(19) United States
(12) Patent Application Publication
(10) Pub. No.: US 2010/0049814 A1
(43) Pub. Date: Feb. 25, 2010

(54) METHOD FOR DISPLAYING ONE OR MORE COMMERCIAL CONTENT ON A BOUNCE EMAIL

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/519,897

(22) PCT Filed: Jul. 3, 2008
(86) PCT No.: PCT/IN08/00420

§ 371 Date: Jun. 18, 2009

(30) Foreign Application Priority Data
Jul. 3, 2007 (IN) 1255/MUM/2007

(51) Int. Cl. G06F 15/16

(52) U.S. Cl. 709/206

(57) ABSTRACT

The present invention relates to a system and method for displaying one or more commercial content on a bounce email. The method comprises determining a failed delivery of an email originating from a first user and destined for a second user. In response to the failed delivery, a bounce email is sent to the first user. One or more commercial content is inserted within the bounce email before sending it to the first user. In an embodiment, the commercial content relevant to the content of the email is inserted in the bounce email.

### FIELD OF THE INVENTION

The invention relates generally to email bounces and, specifically, to method and system for displaying one or more commercial content on a bounce email.

### BACKGROUND OF THE INVENTION

Rising popularity of Internet has led to it becoming a favorable medium for advertising. Thus, building an audience and selling advertisement on free internet services has become a revenue model for various Internet services providers. One such service is Email. Many of the existing email service providers display advertisements alongside emails before sending the emails to the recipients. The email service provider earns revenue from displaying the advertisements and can, hence, offer the email service free of cost to its users.

In a lot of cases, an email sent by a sender may not be delivered to the actual recipient of the email due to a variety of reasons, such as, but not limited to, email address of the recipient being invalid, domain name in the recipient's email address being mistyped, a Mail Exchange (MX) server of the recipient being unavailable etc. A Simple Mail transfer Protocol (SMTP) server of the sender or the recipient, or the MX server of the recipient, or any such server that intercepts the email, can send a bounce email to the sender. A bounce email generally includes standard information such as the number of attempts made to deliver the email, the reason for the failed delivery, etc. However, the existing methods do not use the bounce back mail to deliver additional or customized information to the sender.

Hence, there is a need to use the bounce emails to deliver commercial content to a user.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a block diagram of an environment for monetizing email bounces by displaying one or more commercial content on a bounce email in accordance with various embodiments of the present invention.

FIG. 2 illustrates a flow diagram of a method for displaying one or more commercial content on bounce email in accordance with an embodiment of the present invention.

FIG. 3 illustrates a block diagram of a system for displaying one or more commercial content on bounce email in accordance with an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to displaying one or more commercial content on a bounce email. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of displaying one or more commercial content on a bounce email described herein. The non-processor circuits may include, but are not limited to, a radio receiver, a radio transmitter, signal drivers, clock circuits, power source circuits, and user input devices. As such, these functions may be interpreted as steps of a method and system for displaying one or more commercial content on a bounce email. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to monetizing email bounces by displaying one or more commercial content on a bounce email. Those skilled in the art shall appreciate that the commercial content can be any content that can either have a commercial value such as advertising content, or content that may lead a user to purchase a product or service or even content that can merely be informational in nature such as the weather of a city or stock quotes for the day or restaurants in places the user intends to visit or any such information. For instance, commercial content such as advertisements, weather metadata information, stock quotes etc. can be displayed on the bounce email.

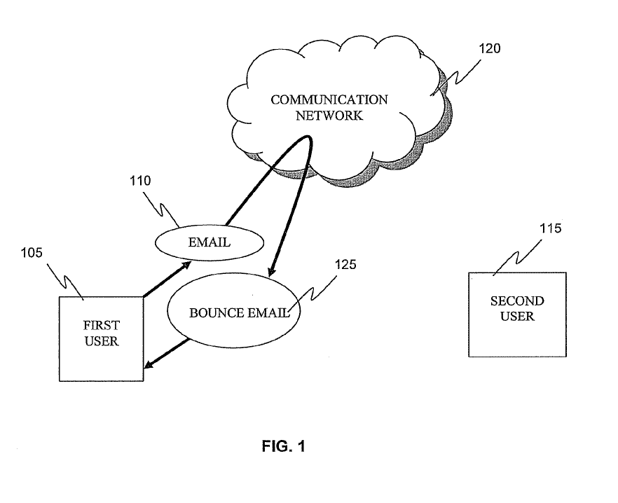

Turning now to FIG. 1, a block diagram of an environment for monetizing email bounces by displaying one or more commercial content on a bounce email is shown in accordance with various embodiments of the present invention. A first user 105 may wish to send an email 110 to a second user 115 through a communication network 120. Communication network 120 can be, but is not limited to, the World Wide Web (WWW), Local Area Network (LAN), Wide Area Network (WAN), etc. For instance, first user 105 may send email 110 from email address user1@XYZ.com to second user 115 with email address user2@ABC.com. An email client of first user 105 sends email 110 to an SMTP Server of an Internet Service Provider (ISP) of first user 105. The SMTP server may, in turn, send a Domain Name System (DNS) request to locate the mail server responsible for handling emails for second user 115. The SMTP server of first user 105 can try to identify the location of an SMTP server which handles emails for second user's 115 domain name, in this case ABC.com, by resolving an MX record. For example, in the case above, the SMTP server of XYZ.com tries to identify the SMTP server of ABC.com to deliver email 110 to second user 115. The implementation of MX records and the DNS resolution processes are known in the art.

Generally, if the email address of second user 115 is mistyped, or does not exist then email 110 may not be delivered to second user 115. When email 110 is not delivered, a bounce email 125 is sent back to first user 105. Bounce email 125 can be sent by the SMTP Server of first user 105, with a notice stating that email 110 cannot be sent to second user 115. Similarly, if the domain name in the email address of second user 115, for instance ABC.com, does indeed resolve and a destination MX record pointing an email server is found, then the SMTP server of first user 105 can attempt to deliver email 110 to such email server of second user 115 as specified in the MX record. In several instances, the MX server may also not be available due to reasons such as network unavailability, bandwidth overload in communication network 120 etc. If the MX server is available, the SMTP server of first user 105 can deliver email 110 and the MX server at second user 115 may then either choose to accept or reject email 110

Email 110 can also be rejected by the MX server of second user 115 under several scenarios. For instance, the MX server has not been configured to accept emails for the domain name in the email address of second user 115 or may have blocked the domain name of first user 105. Alternatively, second user 115 may not exist, or a content filter or policy filter at the MX server of second user 115 may not permit email 110 to go through, for example, if email 110 is detected as spam/junk/phishing or some form of unsolicited email. Similarly, the MX server of second user 115 may also not allow email 110 to be delivered if an email account of second user 115 has exceeded a storage quota allocated. There may also be some other temporary or permanent failures at the MX server level which may cause failure of delivery.

As stated in all the above instances, if the MX server of second user 115 is either unavailable or rejects email 110 sent by the SMTP server of first user 105, the SMTP server of first user 105 can attempt to retry delivery of email 110 for a predetermined period, depending on the configuration parameters at the SMTP server of first user 105. Generally a notice may also be sent to first user 105 in bounce email 125 stating that email 110 could not be sent and that the SMTP server of first user 105 may try to send email 110 again within a predefined time interval. Alternatively, if the MX server of second user 115 accepts email 110, the MX server of second user 115 can either successfully store email 110 in the mailbox of second user 115 or MX server of second user 115 may be configured to forward email 110 to another server that may be the final destination. Those skilled in the art shall appreciate that in this case also the same process described above of sending an email between the SMTP Server of first user 105 and MX Server of second user 115, generally known in the art, would follow.

Those skilled in the art shall appreciate that the above process of email delivery has several scenarios under which an email may not be delivered and a bounce email may be generated. Bounce email can be generated from any given point in the process between the SMTP server of first user 105 or the final destination SMTP Server. Those skilled in the art shall appreciate that the process of email delivery and the scenarios under which an email may bounce back are well known in the art.

In accordance with the present invention, one or more commercial content is inserted in bounce email 125. The one or more commercial content can be any content that can either have a commercial value such as advertising content, or content that may lead a user to purchase a product or service or even content that can merely be informational in nature such as the weather of a city or stock quotes for the day or restaurants in places the user intends to visit or any such information. Further, in accordance with an embodiment of the present invention, the commercial content that is relevant to content in email 110 can be inserted. This ensures, that the commercial content is targeted to first user 105.

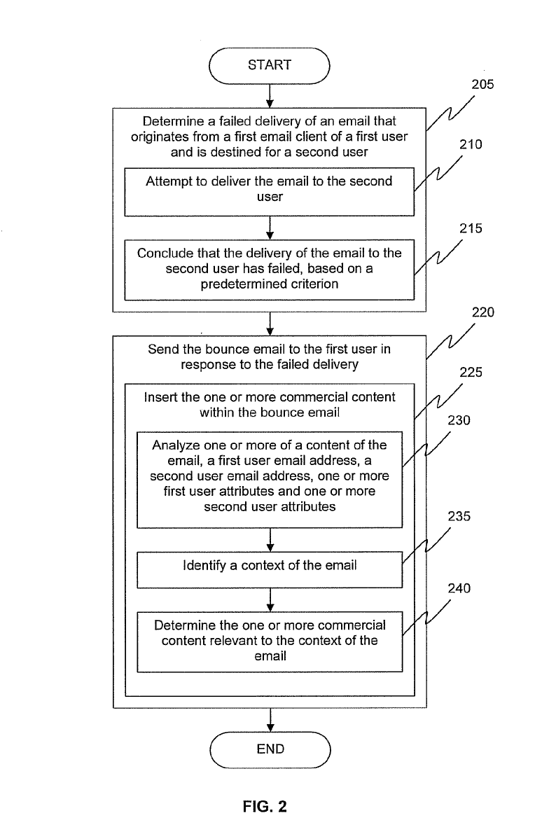

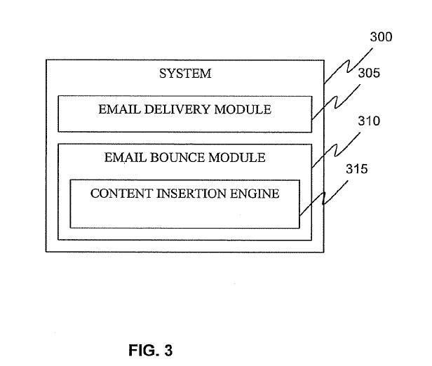

Those skilled in the art will appreciate that the commercial content can be inserted in bounce email 125 by any server, such as the SMTP server of first user 105, the SMTP server of second user 115, the MX server of second user 115 etc., which is responsible for delivering email 110 to second user 115. The method and system for displaying commercial content in bounce email 125 are described in detail in conjunction with FIG. 2 and FIG. 3 below.

Turning now to FIG. 2, a flow diagram of a method for displaying one or more commercial content on bounce email 125 is shown in accordance with an embodiment of the present invention. A failed delivery of email 110, which originates from first user 105 and is destined for second user 115, can be determined at step 205. As mentioned earlier, the failed delivery can be determined by, for instance, the SMTP server of first user 105, the SMTP server of second user 115, the MX server of second user 115, an independent server in communication network 120, etc.

For determining that the delivery of email 110 has failed, any of the servers in the path of the email delivery may attempt to deliver the email, at step 210, to second user 115, say, for a predetermined number of times and/or in a particular interval of time. At step 215, a server, such as the SMTP server of first user 105, the SMTP server of second user 115, the MX server of the second user 115 etc., can conclude that the delivery of email 110 to second user 115 has failed based on a predetermined criterion.

The predetermined criterion can include an email address of second user 115 being non-existent. This may be because the domain name in the email address of second user 115 is non-existent or the username of second user 115 in the email address is mistyped etc. Also, an MX record associated with the domain name in the email address of second user 115 can be absent. Further, the predetermined criterion can include second user 115 blocking emails received from one or more email addresses of first user 105.

The predetermined criterion can also include the MX server of second user 115 being unavailable or the MX server not being configured to accept emails for second user 115. In an embodiment, the MX server may filter out email 110 from being received by second user 115 for reasons such as spam, phishing etc. Alternately, a failed delivery of email 110 may be determined if a storage quota of an email account of second user 115 has reached its maximum threshold.

After determining the failed delivery of email 110, bounce email 125 is sent, at step 220, to first user 105. Bounce email 125 can be sent by any server in the path of the email delivery, such as, but not limited to, the SMTP server of first user 105, the SMTP server of second user 115, the MX server of second user 115, a DNS service provider corresponding to the domain name in the email address of second user 115 and/or the top level domain (TLD) Registry of the domain name in the email address of second user 115. For instance, if the domain name in the email address of second user 115 is mistypes or is non-existent, then the TLD registry of the domain name can also generate bounce email 125. Further, a DNS server responsible for the domain name may also be configured to respond with an address of a special SMTP server to a query for the MX record of the domain name. The special SMTP server can be configured to send bounce email 125 to first user 105.

In accordance with the present invention, one or more commercial content can be inserted, at step 225, in bounce email 125 before sending it to first user 105. The commercial content can be inserted by the same server that generates bounce email 125 or another server in the path of delivery of bounce email 125 to first user 105. For instance, the commercial content can be inserted by the SMTP server of first user 105, the SMTP server of second user 115, the MX server of second user 115, a computing device of second user 115, a computing device of first user 105, an independent server managed by one or more of a DNS service provider of the domain name in the email address of second user 115 and a TLD Registry of the domain name.

For instance, whenever a DNS server of a DNS Provider such as a TLD Registry, Registrar, ISP, or any such entity who owns/operates/manages a DNS Server, gets a query for the MX record of a domain name, if the domain name does not exist or the domain name does not have an MX Record, the DNS server, instead of responding with a “not exists” response for the MX Record, can respond back with an IP address of a special SMTP server which can be responsible for sending a bounce email to the sender, with relevant commercial content. The special SMTP server can be, for example, a server which belongs to the DNS provider or to an entity that the DNS provider may have partnered with to monetize such email bouncebacks. This special SMTP server would accept the email request for such a domain name and correspondingly send a bounce email to the sender with the relevant commercial content or advertisements. The DNS Provider can, hence, monetize the opportunity where it receives MX requests for domain names which do not exist. The DNS Provider may set a low Time To Live (TTL) on such MX responses so as not to disrupt DNS and delivery incase the domain name is activated at a later time.

In an embodiment of the present invention, commercial content that is relevant to first user 105 can be inserted in bounce email 125. For this purpose, a content of email 110, an email address of first user 105, an email address of second user 115 and/or one or more attributes of first user 105 and second user 115 are analyzed at step 230. The attributes of a user can include an age of the user, a location of the user, a past behavior of the user, and one or more pertinent metadata information about first user. The content of email 110 can be analyzed to extract keywords or phrases or information about first user 105 and/or second user 115. Based on such analysis, a context of email 110 can be identified at step 235.

For instance, content of email 110 may include phrases such as “used car sale” etc. which imply that first user 105 may be interested in buying old cars. Thus, the context can be identified as “used car”.

Also, in an embodiment of the present invention, while generating bounce email 125, the SMTP server of first user 105 has the original copy of email 110. The original copy of email 110 can be analyzed by the SMTP server of first user 105 for determining the context of the content within email 110. The commercial content relevant to the context of email 110 can be inserted in bounce email 125. As per one embodiment, since bounce email 125 originates from several stages such as at the SMTP server of first user 105, or the MX Server of second user 115, or any relay server in between, such insertion of commercial content can be performed at any of these servers. For instance, the MX server belonging to second user 115 can insert the commercial content under scenarios where email 110 cannot be delivered to second user 115 due to the reasons described earlier.

At step 240, the commercial content relevant to the context of email 110 can be determined. Those skilled in the art will appreciate that the context of email 110 can be sent to an ad server and commercial content relevant to the context can be obtained from the ad server.

Insertion of commercial content in bounce email 125 can give email service provider, TLD registry, DNS provider etc. an opportunity to monetize such bounce email 125, which otherwise contain only standard information. Further, email services can be provided for free because of this opportunity to monetize the bounce emails.

Turning now to FIG. 3, a block diagram of a system 300 for displaying one or more commercial content on bounce email 125 is shown in accordance with an embodiment of the present invention. System 300 comprises an email delivery module 305 that determines that email 110 cannot be sent to second user 115. Email delivery module 305 can include one or more servers of communication network 120 that are responsible for delivering email 110 from first user 105 to second user 115. For instance, email delivery module 305 can be the SMTP server of first user 105, the SMTP server of second user 115, the MX server of second user 115 etc. To determine that delivery of email 110 has failed, email delivery module 305 attempts to deliver email 110 to second user 115 for predetermined number of times and/or for a predetermined interval of time. Email delivery module 305 may eventually conclude that the delivery of email 110 to second user 115 has failed, based on a predetermined criterion. The predetermined criterion are described in detail in conjunction with FIG. 2 above.

System 300 further includes an email bounce module 310. After email delivery module 305 determines that the delivery of email 110 has failed, email bounce module 310 sends bounce email 125 to first user 105. Email bounce module 310 can be coupled to the SMTP server of first user 105, the SMTP server of second user 115, the MX server of second user 115, a computing device of second user 115, a computing device of first user 105, an independent server managed by a DNS service provider of the domain name in the email address of second user 115 and/or a TLD Registry of the domain name.

In accordance with the present invention, email bounce module 310 can include a content insertion module 315 for inserting one or more commercial content within bounce email 125. Content insertion module 310 can obtain the commercial content from an ad server serving the commercial content.

As per one embodiment, content insertion module 310 is configured to analyze one or more of a content of email 110, an email address of first user 105, an email address of second user 115 and one or more attributes or first user 105 and/or second user 115. Content insertion module 310 can then identify a context of email 110 based on the analysis. The commercial content relevant to the context can then be determined and inserted in bounce email 125. This ensures that the commercial content is relevant to first user 105.

Various embodiments of the present invention facilitate monetization of bounce emails. Bounce emails can be monetized by any server that helps deliver an email from a sender to a recipient. Further, in accordance with an embodiment of the present inventions, commercial content that is relevant to the sender and/or the recipient is inserted in the bounce emails, so as to better target the commercial content. This monetization opportunity can enable an email service provider to provide email service free of cost, or at a cheaper cost, to its users.

What is claimed is:

1. A method for displaying one or more commercial content on a bounce email, the method comprising:
determining a failed delivery of a first email, wherein the first email originates from a first email client of a first user and the first email is destined for a second user; and
sending the bounce email to the first user in response to the failed delivery, wherein the sending step comprises:
inserting the one or more commercial content within the bounce email

2. The method of claim 1, wherein the determining step comprises:
attempting to deliver the first email to the second user; and
concluding that the delivery of the first email to the second user has failed, based on a predetermined criterion.

3. The method of claim 2, wherein the predetermined criterion comprises one or more of:
a second email address of the second user being non-existent;
a domain name corresponding to the second email address being not-existent;
a Mail Exchange (MX) record associated with the domain name corresponding to the second email address being absent;
the second user blocking one or more emails received from a first user email address of the first user;
a MX server corresponding to the second user being unavailable;
a configuration of the MX server to accept one or more emails for the second user being absent;
the MX server filtering the first email from being received by the second user; and
a storage quota of an email account of the second user having reached a maximum threshold.

4. The method of claim 3, wherein if one or more of the domain name corresponding to the second email address is not-existent and a the MX record associated with the domain name corresponding to the second email address is absent, then a DNS server responsible for the domain name responds with an address of a special SMTP server to a query for the MX record of the domain name, wherein the special SMTP server is configured to send the bounce email to the first email client.

5. The method of claim 1, wherein the one or more commercial content is inserted by one or more of an SMTP server of the first user, an SMTP server of the second user, an MX server of the second user, a computing device of the second user, a computing device of the first user, an independent server managed by one or more of a DNS service provider of a domain name corresponding to a second email address of the second user and a Top Level Domain (TLD) Registry of the domain name.

6. The method of claim 1, wherein the inserting step comprises:
analyzing one or more of a content of the first email, a first user email address, a second user email address, one or more first user attributes and one or more second user attributes;
identifying a context of the first email based on the analyzing step; and
determining the one or more commercial content relevant to the context of the first email.

7. The method of claim 6, wherein the one or more first user attributes comprise an age of the first user, a location of the first user, a past behavior of the first user, and one or more pertinent metadata information about the first user, and the one or more second user attributes comprise an age of the second user, a location of the second user, a past behavior of the second user, and one or more pertinent metadata information about the second user.

8. A system for displaying one or more commercial content on a bounce email, the method comprising:
an email delivery module, the email delivery module determining that delivery of a first email is failed, wherein the first email originates from a first email client of a first user and the first email is destined for a second user; and
an email bounce module, the email bounce module configured to send the bounce email to the first user in response to the email delivery module determining the failed delivery of the first email, wherein the email bounce module further comprises:
a content insertion module, the content insertion module inserting the one or more commercial content within the bounce email.

9. The system of claim 8, wherein to determine the failed delivery of the first email, the email delivery module is configured to:
attempt to deliver the first email to the second user; and
conclude that the delivery of the first email to the second user has failed, based on a predetermined criterion.

10. The system of claim 8, wherein the email bounce module is coupled to one or more of an SMTP server of the first user, an SMTP server of the second user, an MX server of the second user, a computing device of the second user, a computing device of the first user, an independent server managed by one or more of a DNS service provider of a domain name corresponding to a second email address of the second user and a Top Level Domain (TLD) Registry of the domain name.

11. The system of claim 8, wherein the content insertion module configured to:
analyze one or more of a content of the first email, a first user email address, a second user email address, one or more first user attributes and one or more second user attributes;
identify a context of the first email based on the analysis; and
determine the one or more commercial content relevant to the context of the first email.
